(19) United States
(12) Patent Application Publication
(10) Pub. No.: US 2008/0202668 A1
(43) Pub. Date: Aug. 28, 2008

(54) BILLBOARD LABEL

(75) Inventors: John A. MacGregor, Hamilton, OH (US); Donald P. Klein, Dell Rapids, SD (US); Robert E. Baum, Dell Rapids, SD (US)

Correspondence Address: WARNER NORCROSS & JUDD LLP, 900 FIFTH THIRD CENTER, 111 LYON STREET, N.W., GRAND RAPIDS, MI, 49503-2487, US

(73) Assignee: CCL LABEL, INC., Sioux Falls, SD (US)

(21) Appl. No.: 11/680,092

(22) Filed: Feb. 28, 2007

(51) Int. Cl. B29C 65/00

(52) U.S. Cl. 156/152; 156/391

(57) ABSTRACT

The specification discloses a label assembly having a portion that projects from a container. The label assembly includes a base layer and a projecting or billboard layer. The billboard layer is partially adhered to the base layer leaving marginal portions that are not adhered to the base layer. The base layer is adapted to conform to the container. The billboard layer is relatively stiff, enabling the marginal portions to extend away from the container.

### BACKGROUND OF THE INVENTION

The present invention relates to labels, and more particularly to labels applied to bottles, containers, or other objects.

Labels for bottles and containers are well known and are in widespread use. These labels typically include printing and/or graphics on their faces and adhesive on their backs. The adhesive secures the label to the bottle so that the printing and/or graphics are visible.

The aesthetics and visibility of the label are important, particularly when the label is used for consumer products. A label can help visually distinguish a product and help the product to stand out from other products. A variety of techniques have been used to enhance the aesthetics and visibility of labels. The techniques include loud colors, metallic inks, holographics, and overlaminates. Nevertheless, there is a continuing need for labels with ever-improved aesthetics and visibility.

### SUMMARY OF THE INVENTION

The label assembly of the present invention is a response to the aforementioned continuing need. The label assembly includes two layers. A first layer is a base layer adapted to be secured to a container in conventional fashion. The second layer is a relatively stiff projecting or “billboard” layer (a) adhered to the base layer in an adhered portion and (b) free of the base layer in at least one marginal portion.

When the label assembly is applied to a bottle, container, or other object, the base layer conforms to the shape of the container. However, the marginal portions of the relatively stiff billboard layer are free to extend away from the base layer and the container. Consequently, the billboard layer stands out from the container to provide a “billboard” effect. The label assembly thereby provides enhanced aesthetics and visibility.

These and other objects, advantages, and features of the invention will be more fully understood and appreciated by reference to the Description of the Current Embodiments and the drawings.

### BRIEF DESCRIPTION OF THE DRAWINGS

FIG. 1 is a perspective view of the label assembly of the present invention applied to a container;

FIG. 2 is a sectional view taken along line II-II in FIG. 1; and

FIG. 3 is a perspective sectional view of the label assembly with the layers artificially stepped for clarity.

### DESCRIPTION OF THE CURRENT EMBODIMENTS

### I. Label Assembly

A label assembly constructed in accordance with a preferred embodiment of the invention is illustrated in the drawings and generally designated 10. The label assembly includes a base layer 12 and a billboard layer 14 intersecured by an adhesive 16.

The container C to which the label assembly 10 is adhered has a generally circular horizontal cross section. However, the container may have virtually any shape. Further, although the present invention is described in conjunction with a container C, the label assembly is suitable for application to virtually any other container and indeed to virtually any object.

In the illustrated embodiment, the base layer 12 is relatively flexible, meaning that it can readily conform to the shape of the container C to which it is adhered. The base layer 12 can be fabricated of any suitable material known to those skilled in the label art. For example, the material may be either plastic or paper—although plastic is currently preferred. Alternatively, the base layer may be fabricated of a heat-shrink material. One or more ink layers 20 may be printed on the top side of the base layer 12.

An adhesive 22 is carried on the bottom side of the base layer 12. The adhesive 22 may be any adhesive suitable for the application—for example a pressure sensitive adhesive or a temperature-activated adhesive. If the adhesive is pressure sensitive, then the base layer 12 typically is temporarily adhered to a release liner 24. If the adhesive is temperature-activated, then the label assembly 10 is particularly well adapted for use as an in-mold label. Alternatively, the base layer 12 may include no adhesive 22, in which case the label assembly 10 is a glue-applied label, meaning that the adhesive is applied to the base layer 12 and/or the container C during the label application process.

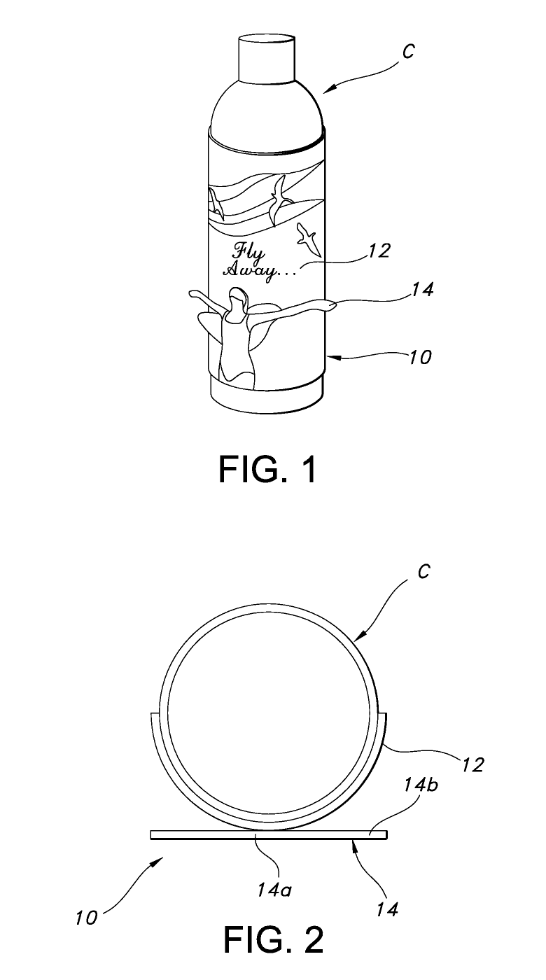

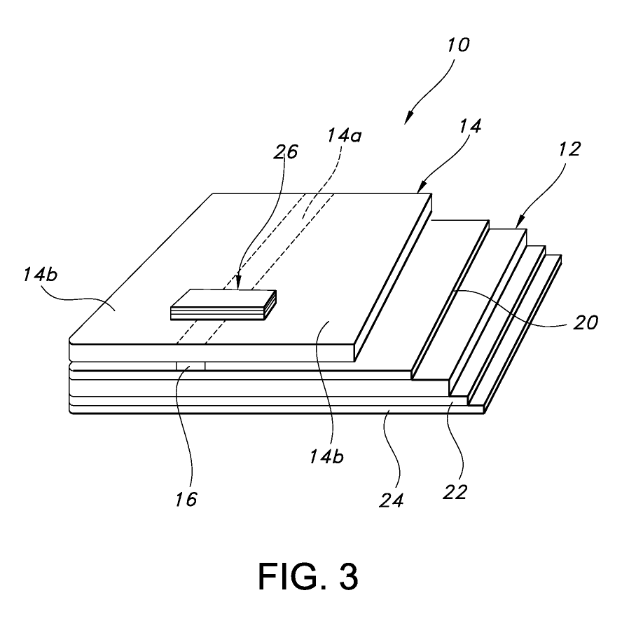

The projecting or billboard layer 14 is relatively stiff, meaning that it has sufficient body or stiffness to maintain its shape even when the base layer 12 is adhered to a container. The projecting layer 14 illustrated in FIG. 1 is essentially planar in shape. However, the layer could be formed to have a non-planar shape. For example, the projecting layer 14 could be shaped as a butterfly with “wings” extending from the container C. The projecting layer 14 can also be fabricated from any suitable material known to those skilled in the label art. For example, the material may be either plastic or paper—although plastic is currently preferred. The projecting layer 14 may include one or more layers 26 of ink, overlaminate, or other printed or applied layers. The projecting layer 14 provides an attractive and eye-catching appearance.

The billboard layer 14 is adhered to the base layer 12 by an adhesive 16. In the current embodiment, the adhesive 16 is pattern printed or otherwise limited from being applied to the entire surface of at least one of the base layer 12 and the projecting layer 14. In the disclosed embodiment, the adhesive 16 secures an adhered portion 14a of the projecting layer 14 to the base layer 12. As disclosed, the adhesive 16 is a relatively narrow linear band. The marginal or adhesive-free portions 14b flank the adhered portion 14a, and the marginal portions 14b are free or able to separate and/or to extend away from the base layer 12 after the base layer is applied to the container C. As illustrated, the billboard layer 14 includes two marginal portions 14b. Alternatively, the billboard layer 14 may include any number of (one or more) marginal portions 14b.

The adhesive 16 can be either a permanent adhesive or a releasable adhesive. If the adhesive 16 is permanent, then the projecting layer 14 cannot be readily removed from the base layer 12. If the adhesive 16 is releasable, then the projecting layer 14 can be readily removed from the base layer 12. In that case, the projecting layer 14 might be used as a game piece, token, coupon, or other device.

The label assembly 10, including the base layer 12 and the projecting layer 14, are illustrated in the drawings in a specific shape. The label assembly can have virtually any shape, and all shapes are considered within the scope of the present invention. Also, the layers 12 and 14 are each illustrated as a single layer. However, each layer may include multiple plies or layers, and such multi-ply or multi-layer constructions are considered within the scope of the present invention.

### II. Manufacture

A wide variety of techniques can be used to manufacture the label assembly 10.

The following described method is one example for manufacturing a pressure sensitive embodiment. (1) The base web is purchased as a sandwich including the base layer 12, the release liner 24, and the pressure sensitive adhesive 22. (2) The base layer 12 is printed with printed layers 20 for example using an ultraviolet (UV) flexographic technique. (3) The projecting web is printed with printed layers 26 for example also using a UV flexographic technique. (4) The adhesive 16 is pattern printed or otherwise applied on the top surface of the base web. (5) The billboard web is brought into engagement with the adhesive 16 and thereby adhered to the base web. (6) The billboard web is die cut to the desire shape, and the excess die-cut matrix is stripped. (7) The base web and possibly the billboard web are die-cut to the overall label shape, and the excess die-cut matrix is stripped, leaving the base individual label assemblies 10 on the release liner 24. Alternatively, all die-cutting could occur in a single step. The resulting label assemblies 10 preferably are equally spaced along the length of the release liner 24 to facilitate subsequent application of the label assemblies to the containers C. (8) The continuous web is wound up into a roll for storage and transportation.

The method of manufacturing the in-mold embodiment and the glue-applied embodiment of the label assemblies 10 will be apparent to those skilled in the label art in view of the described method for manufacturing the pressure sensitive embodiment of the label.

The above descriptions are those of the current embodiments of the invention. Various changes and alterations can be made without departing from the spirit and broader aspects of the invention, which are to be interpreted in accordance with the principles of patent law, including the doctrine of equivalents.

1. A label assembly comprising:
a base layer having a bottom surface and a top surface, said bottom surface adapted to be adhered to an object;
a relatively stiff projecting layer including an adhered portion and a marginal portion separate from said adhered portion; and
adhesive adhering said adhered portion of said projecting layer to said base layer top surface, said marginal portion of said projecting layer being free of said base layer, whereby said marginal portion is free to separate from said base layer.

2. A label assembly as defined in claim 1 wherein said adhesive is pattern printed on at least one of said base layer and said projecting layer.

3. A label assembly as defined in claim 1 wherein said adhesive is permanent adhesive.

4. A label assembly as defined in claim 1 wherein said adhesive is releasable adhesive enabling said projecting layer to be removed from said base layer.

5. A label assembly as defined in claim 1 further comprising a second adhesive on said base layer bottom surface.

6. A label assembly as defined in claim 5 wherein said second adhesive is pressure-sensitive adhesive.

7. A label assembly as defined in claim 5 wherein said second adhesive is temperature-activated adhesive.

8. A labeled container assembly comprising:
a container; and
a label assembly adhered to said container, said label assembly including:
a base layer adhered and conforming to said container; and
a projecting layer having an adhered portion adhered to said base layer and a marginal portion extending away from said base layer.

9. A labeled container assembly as defined in claim 8 wherein said label assembly includes pattern-printed adhesive adhering said projecting layer to said base layer.

10. A labeled container assembly as defined in claim 8 wherein said projecting layer is permanently adhered to said base layer.

11. A labeled container assembly as defined in claim 8 wherein said projecting layer is releasably adhered to said base layer.

12. A labeled container assembly as defined in claim 8 wherein said base layer is adhered to said container by a pressure-sensitive adhesive.

13. A labeled container assembly as defined in claim 8 wherein said base layer is adhered to said container by a temperature-activated adhesive.

14. A labeled container assembly as defined in claim 8 wherein said base layer is adhered to said container by a wet adhesive.

15. A method of manufacturing a label assembly comprising:
adhering a relatively stiff web to a base web in selected areas less than the entire area of at least one of the webs;
die cutting the relatively stiff web and the base web to form individual label assemblies each including at least one of the selected areas and an adhesive-free area mutually separate from the at least one selected area; and
stripping the waste matrix from the die-cut webs leaving the individual label assemblies each including a base layer and a relatively stiff projecting layer adhered to the base layer in the selected areas and free of the base layer in the adhesive-free areas.

16. A method as defined in claim 15 wherein said adhering step includes pattern printing adhesive on at least one of the relatively stiff web and the base web.

17. A method as defined in claim 15 wherein said adhering step comprises permanently adhering.

18. A method as defined in claim 15 wherein said adhering step comprises temporarily adhering.

19. A method as defined in claim 15 wherein the base web is releasably adhered to a release liner, whereby the individual label assemblies remain on the release liner.
